(19) United States
(12) Patent Application Publication
(10) Pub. No.: US 2011/0002197 A1
(43) Pub. Date: Jan. 6, 2011

(54) Integrated circuit for electronic timepiece and electronic timepiece

(76) Inventors: Kenji Ogasawara, Chiba-shi (JP); Akira Takakura, Chiba-shi (JP); Saburo Manaka, Chiba-shi (JP); Kazumi Sakumoto, Chiba-shi (JP); Hiroshi Shimizu, Chiba-shi (JP); Keishi Honmura, Chiba-shi (JP); Eriko Noguchi, Chiba-shi (JP); Kazuo Kato, Chiba-shi (JP); Takanori Hasegawa, Chiba-shi (JP); Tomohiro Ihashi, Chiba-shi (JP); Kosuke Yamamoto, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/803,560

(22) Filed: Jun. 29, 2010

(30) Foreign Application Priority Data
Jul. 2, 2009 (JP) 2009-158220

(51) Int. Cl. G04C 9/00

(52) U.S. Cl. 368/187

(57) ABSTRACT

In response to a system reset signal inputted into a system reset port, a control circuit sets a general-purpose port to a high level first. Then, when a mode A is set in an integrated circuit for electronic timepiece, the control circuit sets the general-purpose output port to a low level after an elapse of a first time and when a mode B is set, it sets the general-purpose output port to a low level after an elapse of a second time. In this manner, a mode information signal having a pulse width corresponding to the mode is outputted from the general-purpose output port. It thus becomes possible to reduce the size without adding a special configuration for mode confirmation and to perform a confirmation in a short time.

### BACKGROUND OF THE INVENTION

1. Field of the Invention

The present invention relates to an integrated circuit for electronic timepiece used in an electronic timepiece and an electronic timepiece using the integrated circuit for electronic timepiece.

2. Background Art

There is an integrated circuit (IC) for electronic timepiece configured in such a manner that one mode can be selected from a plurality of modes. By selecting a mode to be used, an integrated circuit for electronic timepiece set in the selected mode is formed. An example is described, for example, in JP-A-2000-46967. An electronic timepiece in the selected mode is fabricated using the integrated circuit for electronic timepiece in the mode thus set.

In which mode the integrated circuit for electronic timepiece is selectively set is confirmed by making a visual check or vision recognition by putting a mark on the circuit board, monitoring a motor drive pulse waveform in the case of an analog timepiece, or displaying the model code or the like on the liquid crystal display (LCD) in the case of a digital timepiece. The confirmation therefore has problems that it requires manpower and it takes a time due to complexity of discrimination. In addition, the need to additionally provide a component exclusively used to confirm the set mode raises another problem that the size is increased.

### SUMMARY OF THE INVENTION

It is an aspect of the present invention to make it possible to reduce the size without adding a special configuration for mode confirmation and to perform a confirmation in a short time.

An integrated circuit for electronic timepiece according to the aspect of the invention is an integrated circuit for electronic timepiece that is set in a mode selected from a plurality of modes of an electronic timepiece provided in a selectable manner. The integrated circuit for electronic timepiece includes a mode information output section that outputs a mode information signal indicating a set mode from a normally provided output port.

An electronic timepiece according to another aspect of the invention is an electronic timepiece furnished with at least a time display capability and including the integrated circuit for electronic timepiece configured as above.

It thus becomes possible to reduce the size without adding a special configuration for mode confirmation and to perform a confirmation in a short time.

### BRIEF DESCRIPTION OF THE DRAWINGS

FIG. 1 is a block diagram common with integrated circuits for electronic timepiece according to first through fourth embodiments of the invention;

FIG. 2 is a block diagram of an integrated circuit for electronic timepiece according to a fifth embodiment of the invention;

FIG. 3 is a timing chart of an integrated circuit for electronic timepiece according to a first embodiment of the invention;

FIG. 4 is a timing chart of an integrated circuit for electronic timepiece according to a second embodiment of the invention;

FIG. 5 is a timing chart of an integrated circuit for electronic timepiece according to a third embodiment of the invention;

FIG. 6 is a timing chart of an integrated circuit for electronic timepiece according to a fourth embodiment of the invention;

FIG. 7 is a flowchart of the integrated circuit for electronic timepiece according to the first embodiment of the invention;

FIG. 8 is a flowchart of the integrated circuit for electronic timepiece according to the second embodiment of the invention;

FIG. 9 is a flowchart of the integrated circuit for electronic timepiece according to the third embodiment of the invention; and

FIG. 10 is a flowchart of the integrated circuit for electronic timepiece according to the fourth embodiment of the invention.

### DESCRIPTION OF THE PREFERRED EMBODIMENTS

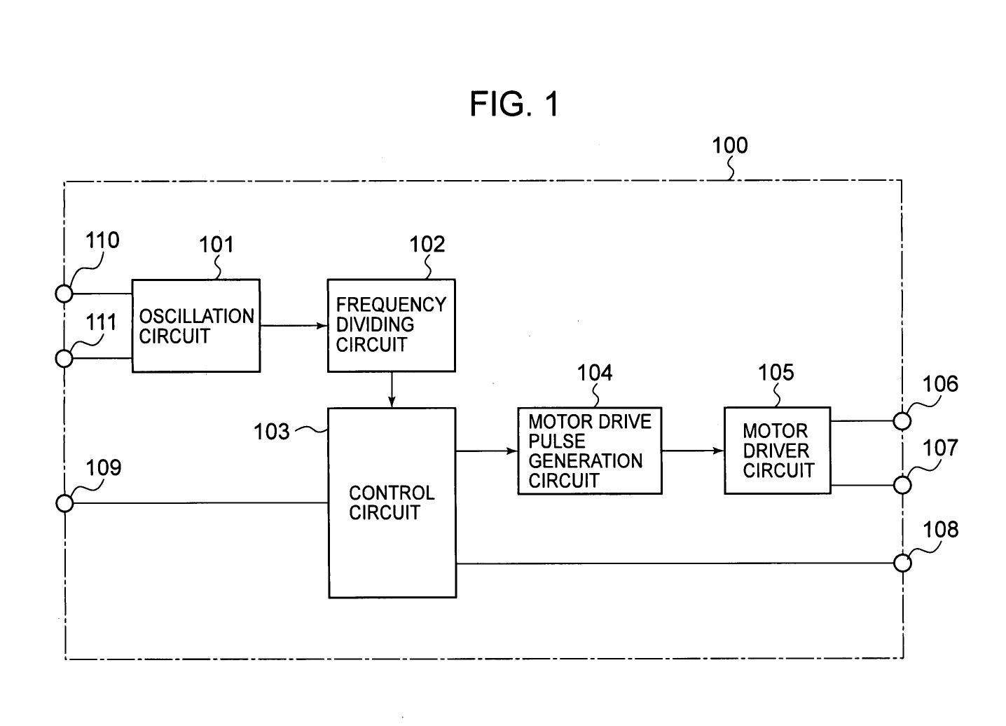

FIG. 1 is a block diagram of an integrated circuit (IC) 100 for electronic timepiece according to embodiments of the invention. It is a block diagram common with first through fourth embodiments and shows an example of an integrated circuit for analog electronic timepiece including an integrated circuit for chronograph timepiece.

Referring to FIG. 1, the integrated circuit 100 for electronic timepiece includes an oscillation circuit 101 that generates a signal at a predetermined frequency, a frequency dividing circuit 102 that divides the signal generated in the oscillation circuit 101 to generate a timepiece signal that will serve as the timekeeping reference, a control circuit 103 that controls a timekeeping operation and respective electronic circuit elements forming an electronic timepiece or performs control, such as change control of a drive pulse, a motor drive pulse generation circuit 104 that outputs a drive pulse corresponding to a control signal from the control circuit 103, and a motor driver circuit 105 that outputs a motor drive signal to rotary drive a stepping motor (not shown) according to the drive pulse from the motor drive pulse generation circuit 104 from motor drive signal output ports 106 and 107, which are one type of output port. The control circuit 103 can be formed of a central processing unit (CPU) and a storage portion that has stored a program. In this case, programs in a plurality of modes may be stored, so that a mode can be selected by selecting any one of the stored programs.

The oscillation circuit 101 oscillates at a predetermined frequency using a crystal oscillator (not shown) connected to ports 110 and 111 as the source of oscillation. The motor driver circuit 105 rotary controls the stepping motor for driving timepiece hands or a chronograph hand connected to the motor drive signal output ports 106 and 107 by supplying the motor drive signal. Numeral 108 is one type of output port and it is a general-purpose output port from which various signals are outputted. The general-purpose output port 108 is a port normally provided to a typical integrated circuit for electronic timepiece. Numeral 109 is a system reset port.

Although it is not shown in the drawing, the integrated circuit 100 for electronic timepiece includes mode portions of a plurality of types inside, so that it is set in a mode selected from a plurality of modes of the electronic timepiece provided in a selectable manner.

It should be noted that the control circuit 103 forms a mode information output section.

The mode information output section is able to output a mode information signal indicating the set mode from an output port normally provided to the integrated circuit 100 for electronic timepiece. The term, “the output port normally provided”, referred to herein is used with an intention to exclude an additionally provided port that is exclusively used to output the mode information signal. Examples include a general-purpose port, a reference timepiece output port for timepiece accuracy adjustment for adjustment of timepiece accuracy, and a motor drive signal output port. Besides these ports, the term includes a port normally provided to the integrated circuit for electronic timepiece for adjustment, test, and measurement.

The mode information output section is also able to output a mode information signal having a pulse width corresponding to the set mode from the output port.

The mode information output section is also able to output a mode information signal at a frequency corresponding to the set mode from the output port.

As the output port, for example, a general-purpose port or an output port for signal adjustment for timepiece for adjustment of a signal frequency for timepiece is used.

Also, the output port is a motor drive signal output port from which a motor drive signal is outputted. The mode information output section is therefore able to output a mode information signal using the motor drive signal from the motor drive signal output port.

The mode information output section is also able to output the motor drive signal generated at timing corresponding to the set mode from the motor drive signal output port as the mode information signal.

The mode information output section is also able to indicate a mode that differs depending on whether the mode information signal includes an identifying pulse signal in phase with the motor drive signal outputted immediately before.

The mode information output section is also able to output the mode information signal from the output port in response to a system reset signal.

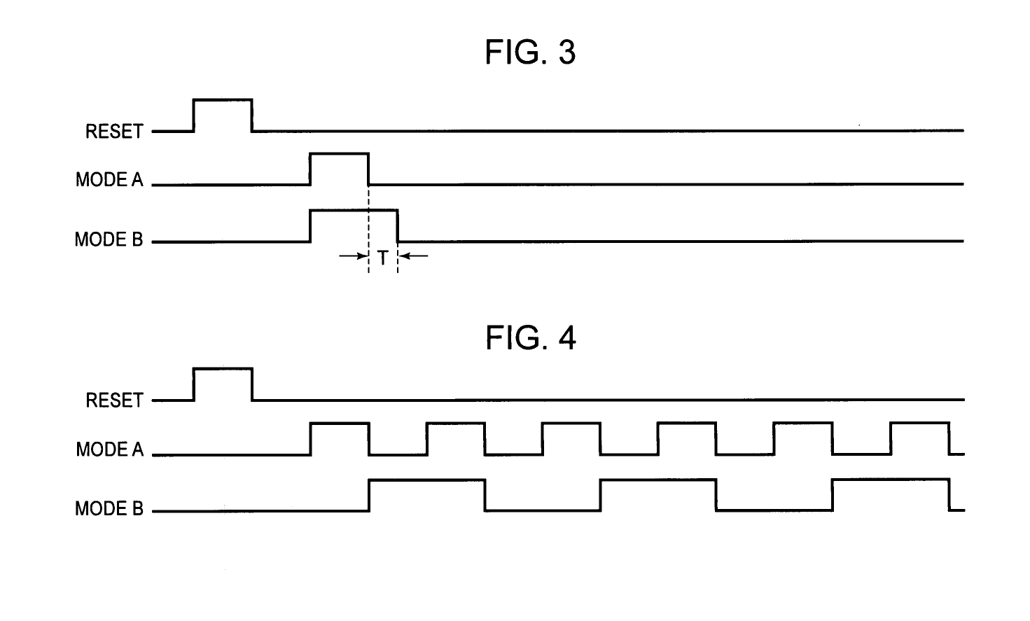

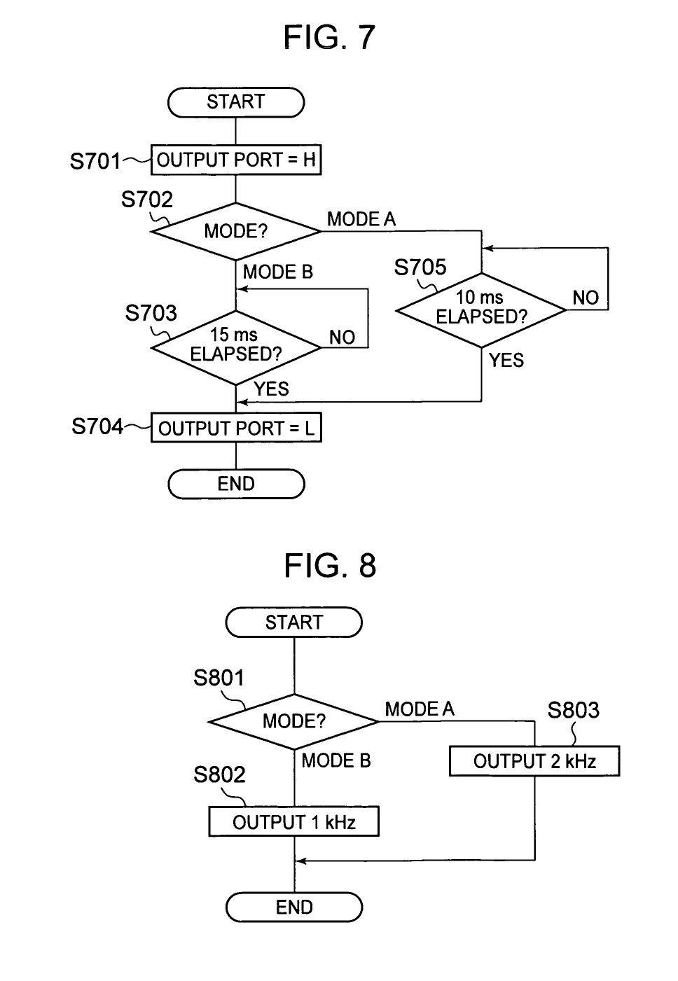

FIG. 3 is a timing chart of the integrated circuit for electronic timepiece according to the first embodiment of the invention. FIG. 7 is a flowchart of the integrated circuit for electronic timepiece according to the first embodiment of the invention.

Hereinafter, an operation of the integrated circuit for electronic timepiece according to the first embodiment of the invention will be described using FIG. 1, FIG. 3, and FIG. 7.

Upon input of a system reset signal RESET at a high (H) level in the system reset port 109 (see FIG. 3), the control circuit 103 sets the general-purpose output port 108 to a high (H) level in response to the system reset signal RESET (Step S701 in FIG. 7).

The control circuit 103 then determines the set mode. When the set mode is a mode A (Step S702), the control circuit 103 sets the general-purpose output port 108 to a low (L) level (Step S704) after an elapse of a predetermined first time (for example, 10 ms) (Step S705). Accordingly, in a case where the integrated circuit 100 for electronic timepiece is set in the mode A, a mode information signal having a time width of the first time (a mode information signal indicating that the mode A is set) is outputted.

Meanwhile, when the set mode is a mode B (Step S702), after an elapse of a second time (for example, 15 ms) having a length of a predetermined time (for example, a time T) different from that of the first time (Step S703), the control circuit 103 sets the general-purpose output port 108 to a low (L) level (Step S704). Accordingly, in a case where the integrated circuit 100 for electronic timepiece is set in the mode B, a mode information signal having a time width of the second time (a mode information signal indicating that the mode B is set) is outputted.

In this manner, in response to the system reset signal RESET inputted into the system reset port 109, the control circuit 103 outputs the mode information signal having the first time width from the general-purpose output port 108 when the mode A is set in the integrated circuit 100 for electronic timepiece and outputs the mode information signal having the second time width from the general-purpose output port 108 when the mode B is set. The mode information signal having the pulse width that differs with the modes is thus outputted from the general-purpose output port 108. Hence, the mode set in the integrated circuit 100 for electronic timepiece can be determined according to the mode information signal.

It thus becomes possible to reduce the size without adding a special configuration for mode confirmation and to perform a confirmation in a short time. Also, it becomes possible to confirm the mode in which the integrated circuit 100 for electronic timepiece is set electrically and readily in a short time according to the mode information signal outputted from the general-purpose output port 108. Further, because the mode information signal is outputted from the output port normally provided to the integrated circuit, there is no need to add a special configuration, such as an inspection terminal for mode confirmation. The size can be therefore reduced at a low cost. Moreover, the mode information signal, which is a signal that differs with the modes, is outputted from the output port after the system is reset by the system reset signal. In addition, when an electronic timepiece incorporating the integrated circuit for electronic timepiece of this embodiment is assembled, it becomes possible to prevent an integrated circuit for electronic timepiece in a different mode from being used erroneously.

Regarding the processing for the control circuit 103 to determine the set mode, various methods can be adopted. For example, the processing may be carried out by being incorporated into the set mode itself or the type of the set mode may be stored in an internal storage portion of the control circuit 103, so that a set information signal corresponding to the stored content is outputted from the general-purpose output port 108. The same can be said in the respective embodiments described below.

FIG. 4 is a timing chart of an integrated circuit for electronic timepiece according to a second embodiment of the invention. FIG. 8 is a flowchart of the integrated circuit for electronic timepiece of the second embodiment. The block diagram of the second embodiment is the same as FIG. 1.

Hereinafter, an operation of the integrated circuit for electronic timepiece of the second embodiment will be described using FIG. 1, FIG. 4, and FIG. 8.

Upon input of a system reset signal RESET at a high (H) level in the system reset port 109 (see FIG. 4), the control circuit 103 determines the set mode. When the set mode is the mode A (Step S801), the control circuit 103 outputs a mode information signal at a first frequency (for example, 2 kHz) (a mode information signal indicating that the mode A is set) from the general-purpose output port 108 using a signal from the frequency dividing circuit 102 (Step S803).

Meanwhile, when the control circuit 103 determines that the set mode is the mode B (Step S801), it outputs a mode information signal at a second frequency (for example, 1 kHz) different from the first frequency (a mode information signal indicating that the mode B is set) from the general-purpose output port 108 (Step S802).

In this manner, the mode information signal at a frequency that differs with the modes is outputted from the general-purpose output port 108. Hence, as with the first embodiment above, it becomes possible to confirm the mode in which the integrated circuit 100 for electronic timepiece is set readily in a short time according to the mode information signal outputted from the general-purpose output port 108. In addition, because the mode information signal is outputted from the output port, there is no need to additionally provide an exclusive-use configuration. Hence, there can be achieved an advantage that the size can be reduced at a low cost.

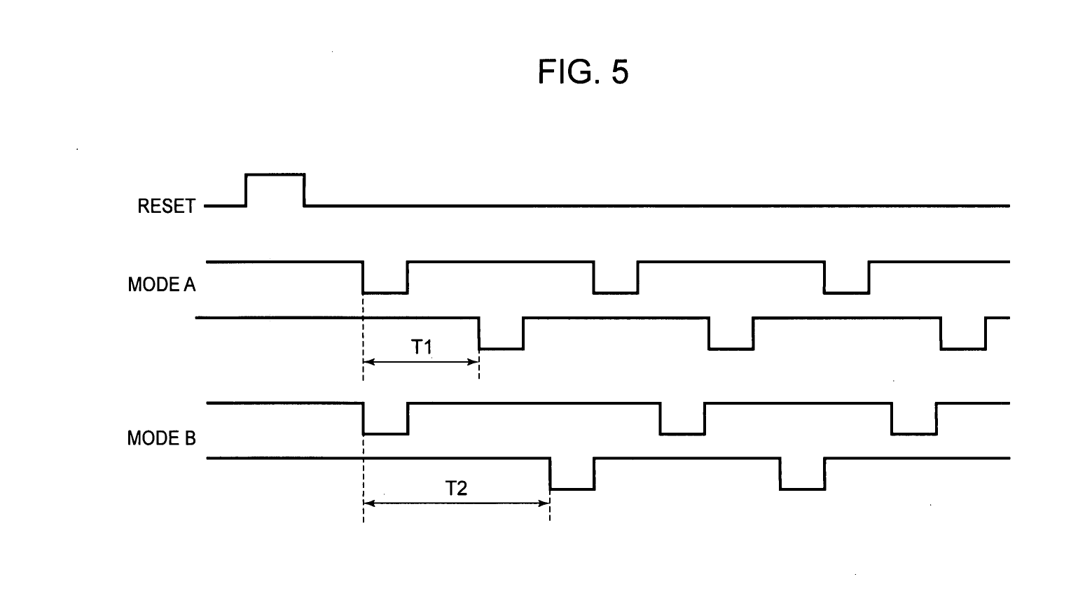

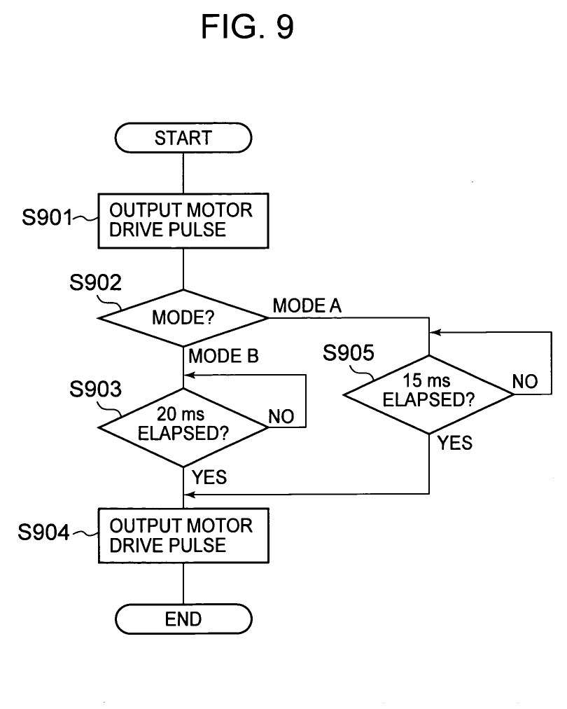

FIG. 5 is a timing chart of an integrated circuit for electronic timepiece according to a third embodiment of the invention. FIG. 9 is a flowchart of the integrated circuit for electronic timepiece of the third embodiment. The block diagram of the third embodiment is the same as FIG. 1.

Hereinafter, an operation of the integrated circuit for electronic timepiece of the third embodiment will be described using FIG. 1, FIG. 5, and FIG. 9.

Upon input of a system reset signal RESET at a high (H) level in the system reset port 109 (see FIG. 5), the control circuit 103 controls the motor drive pulse generation circuit 104 and the motor driver circuit 105 to output a motor drive signal from the motor drive signal output ports 106 and 107 in response to the system reset signal RESET (Step S901). Accordingly, a first motor drive signal is outputted from the motor drive signal output ports 106 and 107.

The control circuit 103 then determines the set mode. When the set mode is the mode A (Step S902), after an elapse of a predetermined third time T1 (for example, 15 ms), which is a drive cycle of the stepping motor (Step S905), the control circuit 103 controls the motor drive pulse generation circuit 104 and the motor driver circuit 105 to output a second motor drive signal from the motor drive signal output ports 106 and 107 (Step S904). Accordingly, in a case where the integrated circuit 100 for electronic timepiece is set in the mode A, two motor drive signals are outputted at an interval of the third time T1 from the motor drive signal output ports 106 and 107 as the mode information signal in response to the system reset signal RESET.

Meanwhile, when the control circuit 103 determines that the set mode is the mode B (Step S902), after an elapse of a fourth time T2 (for example, 20 ms) different from the third time T1 (Step S903), the control circuit 103 controls the motor drive pulse generation circuit 104 and the motor driver circuit 105 to output the second motor drive signal from the motor drive signal output ports 106 and 107 (Step S904). Accordingly, in a case where the integrated circuit 100 for electronic timepiece is set in the mode B, two motor drive signals are outputted at an interval of the fourth time T2 from the motor drive signal output ports 106 and 107 as the mode information signal in response to the system reset signal RESET. Thereafter, the stepping motor is driven under control by an output of the motor drive signal to the motor drive signal output ports 106 and 107 after every elapse of the third time T1, which is the drive cycle of the stepping motor.

In a chronograph timepiece configured to perform an operation (second hand demonstration operation) that turns the chronograph hand using a motor drive pulse for driving the chronograph hand to show that the chronograph operates normally after the system reset, it is normal to use the initial motor drive signal for driving the chronograph hand after the system reset for the second hand demonstration operation.

By changing the interval (frequency) of the motor drive signals for second hand demonstration operation outputted from the motor drive signal output ports 106 and 107 according to the set mode, as with the first embodiment above, it becomes possible to confirm the mode in which the integrated circuit 100 for electronic timepiece is set readily and in a short time according to the mode information signal outputted from the general-purpose output port 108. Also, because the mode information signal is outputted from the output ports, there is no need to additionally provide an exclusive-use configuration. Hence, there can be achieved an advantage that the size can be reduced at a low cost.

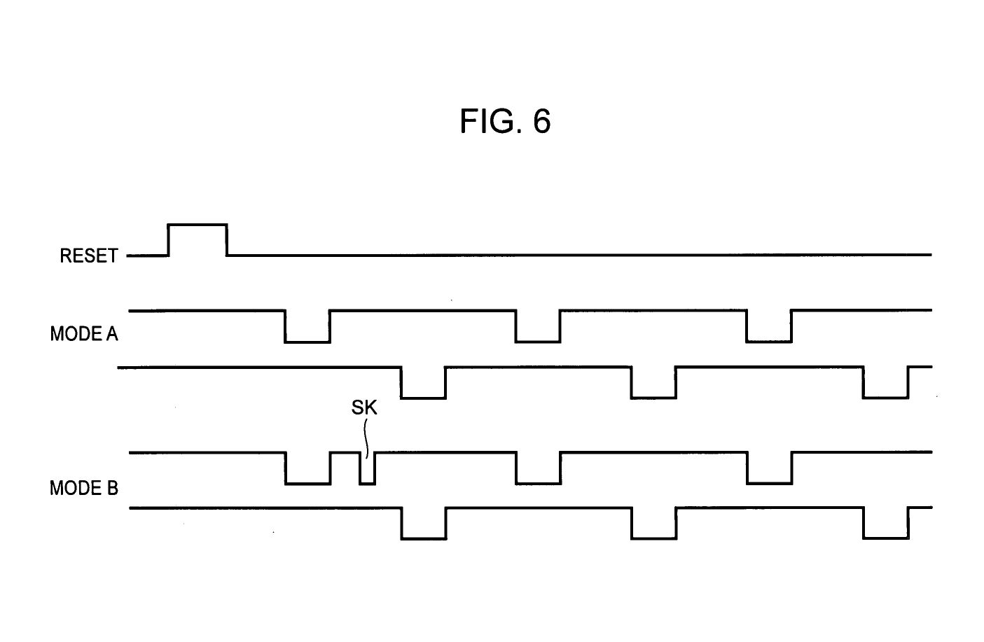

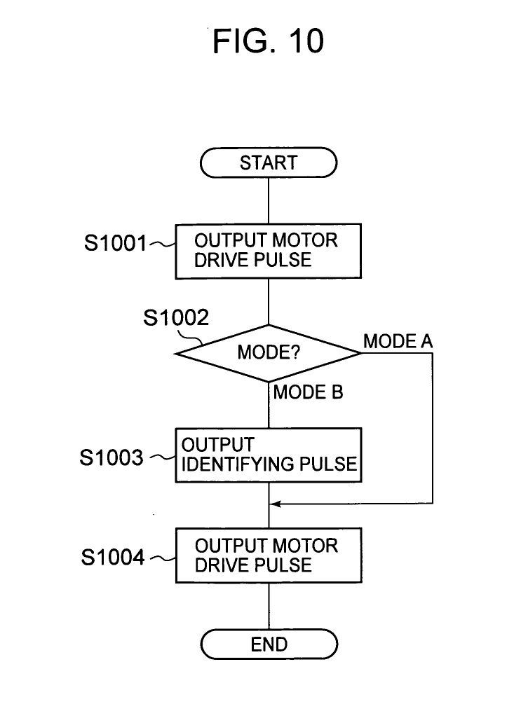

FIG. 6 is a timing chart of an integrated circuit for electronic timepiece according to a fourth embodiment of the invention. FIG. 10 is a flowchart of the integrated circuit for electronic timepiece of the fourth embodiment. The block diagram of the fourth embodiment is the same as FIG. 1.

Hereinafter, an operation of the integrated circuit for electronic timepiece of the fourth embodiment will be described using FIG. 1, FIG. 6, and FIG. 10.

Upon input of a system reset signal RESET at a high (H) level in the system reset port 109 (see FIG. 6), the control circuit 103 controls the motor drive pulse generation circuit 104 and the motor driver circuit 105 to output a motor drive signal from the motor drive signal output ports 106 and 107 in response to the system reset signal RESET (Step S1001). Accordingly, a first motor drive signal is outputted from the motor drive signal output ports 106 and 107.

Subsequently, the control circuit 103 determines the set mode. When the set mode is the mode A (Step 51002), the control circuit 103 controls the motor drive pulse generation circuit 104 and the motor driver circuit 105 to output a normal motor drive signal of the stepping motor from the motor drive signal output ports 106 and 107 (Step 51004). Accordingly, in a case where the integrated circuit 100 for electronic timepiece is set in the mode A, a normal motor drive signal is outputted from the motor drive signal output ports 106 and 107 as the mode information signal.

Meanwhile, when the control circuit 103 determines that the set mode is the mode B (Step S1002), it controls the motor drive pulse generation circuit 104 and the motor driver circuit 105 to output an identifying pulse signal SK from the motor drive signal output ports 106 and 107 after the motor drive signal (the motor drive signal outputted in Step S1001) outputted immediately before (Step S1003). The identifying pulse signal SK is a pulse signal having a predetermined time width and in phase with the motor drive signal (the motor drive signal outputted in Step S1001) outputted immediately before. Because the identifying pulse signal SK is in phase with the motor drive signal outputted immediately before, even when the stepping motor is connected to the motor drive signal output ports 106 and 107, rotations of the stepping motor remains unsusceptible.

Thereafter, the control circuit 103 controls the motor drive pulse generation circuit 104 and the motor driver circuit 105 to output the motor drive signal from the motor drive signal output ports 106 and 107 (Step S1004).

Accordingly, in a case where the integrated circuit 100 for electronic timepiece is set in the mode A, a normal motor drive signal is outputted from the motor drive signal output ports 106 and 107 as the mode information signal. Meanwhile, in a case where the integrated circuit 100 for electronic timepiece is set in the mode B, a motor drive signal including the identifying pulse signal SK is outputted from the motor drive signal output ports 106 and 107 as the mode information signal.

Hence, advantages same as those of the first embodiment above can be achieved in the fourth embodiment, too. In addition, because the identifying pulse signal SK in phase with the immediately proceeding motor drive signal is used, there can be achieved an advantage that rotations of the stepping motor remain unsusceptible.

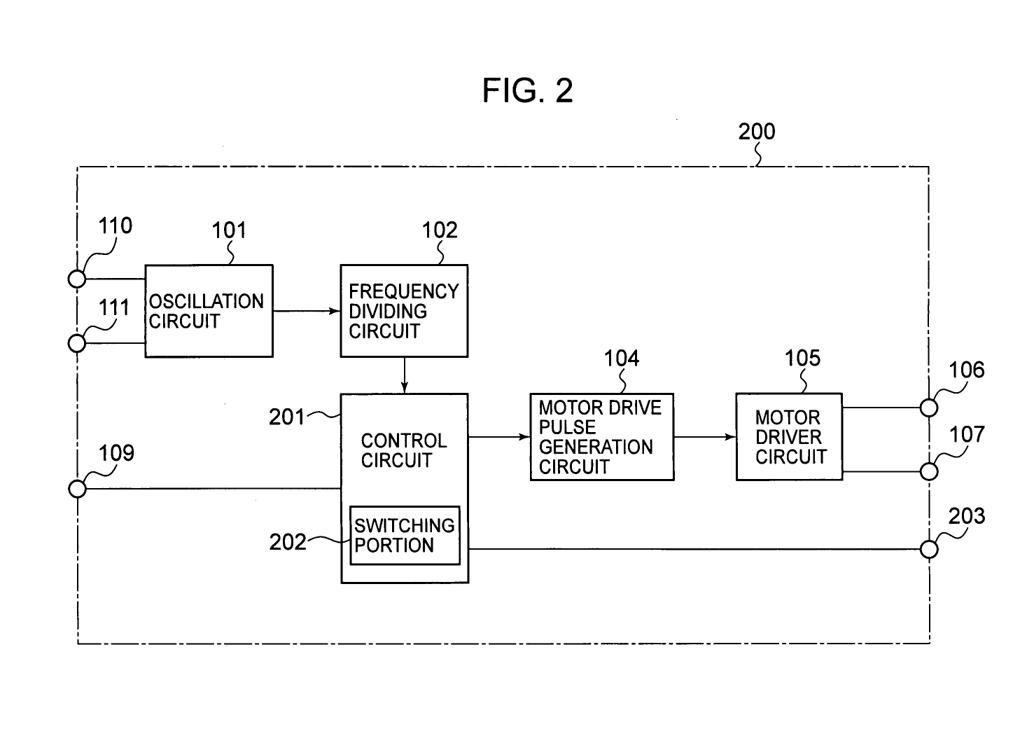

FIG. 2 is a block diagram of an integrated circuit (IC) 200 for electronic timepiece according to a fifth embodiment of the invention and it shows an example of an integrated circuit for analog electronic timepiece including an integrated circuit for a chronograph timepiece. Like components are labeled with like reference numerals with respect to FIG. 1.

In the fifth embodiment, an output port 203 for signal adjustment for timepiece from which a frequency signal is outputted to adjust the frequency of a signal for timepiece (for example, the oscillation frequency of the oscillation circuit 101) is used as the output port from which the mode information signal is outputted. The output port 203 for signal adjustment for timepiece is a port normally provided to the integrated circuit for electronic timepiece as a port for frequency adjustment.

Although it is not shown in the drawing, the integrated circuit 200 for electronic timepiece also includes a plurality of mode portions inside, so that it is set in a mode selected from a plurality of modes of the electronic timepiece provided in a selectable manner.

During the frequency adjustment, the control circuit 201 outputs a signal inputted from the frequency dividing circuit 102 from the output port 203 for signal adjustment for timepiece.

Meanwhile, upon input of a system reset signal at a high level in the system reset port 109, the control circuit 201 controls the output port 203 for signal adjustment for timepiece to serve as a mode identifying signal output port by switching a switching portion 202 under control. Thereafter, the mode identifying signal is outputted from the output port 203 for signal adjustment for timepiece in the same manner as in the first and second embodiments above. Accordingly, advantages same as those of the first and second embodiments above can be achieved.

It should be appreciated that the respective embodiments above are adoptable to an integrated circuit for analog electronic timepiece or digital electronic timepiece as an integrated circuit for electronic timepiece.

Also, the respective embodiments above are applicable to an integrated circuit for electronic timepiece of various types, such as an analog timepiece having a single or two or more stepping motors, an electronic timepiece with a calendar capability, and a chronograph timepiece.

The motor drive signal output port can be selected to suit the configuration of the integrated circuit for electronic timepiece from a motor drive signal output port for driving of the timepiece hands drive motor or a motor drive signal output port for driving of the chronograph hand drive motor.

As has been described, the invention is applicable to an integrated circuit for electronic timepiece of various types including a digital electronic timepiece, an analog electronic timepiece, a chronograph timepiece, and an electronic timepiece with a calendar capability and to an electronic timepiece using such an integrated circuit.

What is claimed is:

1. An integrated circuit for electronic timepiece that is set in a mode selected from a plurality of modes of an electronic timepiece provided in a selectable manner, comprising:
a mode information output section that outputs a mode information signal indicating a set mode from a normally provided output port.

2. An integrated circuit for electronic timepiece according to claim 1, wherein:
the mode information output section outputs a mode information signal having a pulse width corresponding to the set mode from the output port.

3. An integrated circuit for electronic timepiece according to claim 1, wherein:
the mode information output section outputs a mode information signal at a frequency corresponding to the set mode from the output port.

4. An integrated circuit for electronic timepiece according to claim 1, wherein:
the output port is one of a general-purpose port and a reference timepiece output port for timepiece accuracy adjustment for adjustment of timepiece accuracy.

5. An integrated circuit for electronic timepiece according to claim 2, wherein:
the output port is one of a general-purpose port and a reference timepiece output port for timepiece accuracy adjustment for adjustment of timepiece accuracy.

6. An integrated circuit for electronic timepiece according to claim 3, wherein:
the output port is one of a general-purpose port and a reference timepiece output port for timepiece accuracy adjustment for adjustment of timepiece accuracy.

7. An integrated circuit for electronic timepiece according to claim 1, wherein:
the output port is a motor drive signal output port from which a motor drive signal is outputted; and
the mode information output section outputs the mode information signal using the motor drive signal from the motor drive signal output port.

8. An integrated circuit for electronic timepiece according to claim 7, wherein:
the mode information output section outputs a motor drive signal generated at timing corresponding to the set mode from the motor drive signal output port as the mode information signal.

9. An integrated circuit for electronic timepiece according to claim 7, wherein:
the mode information output section indicates a mode that differs depending on whether the mode information signal includes an identifying pulse signal in phase with the motor drive signal outputted immediately before.

10. An integrated circuit for electronic timepiece according to claim 8, wherein:
the mode information output section indicates a mode that differs depending on whether the mode information signal includes an identifying pulse signal in phase with the motor drive signal outputted immediately before.

11. An integrated circuit for electronic timepiece according to claim 1, wherein:
the mode information output section outputs the mode information signal from the output port in response to a system reset signal.

12. An integrated circuit for electronic timepiece according to claim 2, wherein:
the mode information output section outputs the mode information signal from the output port in response to a system reset signal.

13. An integrated circuit for electronic timepiece according to claim 3, wherein:
the mode information output section outputs the mode information signal from the output port in response to a system reset signal.

14. An integrated circuit for electronic timepiece according to claim 4, wherein:
the mode information output section outputs the mode information signal from the output port in response to a system reset signal.

15. An integrated circuit for electronic timepiece according to claim 5, wherein:
the mode information output section outputs the mode information signal from the output port in response to a system reset signal.

16. An integrated circuit for electronic timepiece according to claim 6, wherein:
the mode information output section outputs the mode information signal from the output port in response to a system reset signal.

17. An integrated circuit for electronic timepiece according to claim 7, wherein:
the mode information output section outputs the mode information signal from the output port in response to a system reset signal.

18. An integrated circuit for electronic timepiece according to claim 8, wherein:
the mode information output section outputs the mode information signal from the output port in response to a system reset signal.

19. An integrated circuit for electronic timepiece according to claim 9, wherein:
the mode information output section outputs the mode information signal from the output port in response to a system reset signal.

20. An electronic timepiece furnished with at least a time display capability and comprising the integrated circuit for electronic timepiece according to claim 1.
